(19) United States
(12) Patent Application Publication
(10) Pub. No.: US 2006/0133504 A1
(43) Pub. Date: Jun. 22, 2006

(54) Deblocking filters for performing horizontal and vertical filtering of video data simultaneously and methods of operating the same

(75) Inventors: Deuk-soo Jung, Seoul (KR); Chang-young Jung, Seoul (KR); Yong-mi Lee, Gyeonggi-do (KR); Jung-sun Kang, Gyeonggi-do (KR)

Correspondence Address: MYERS BIGEL SIBLEY & SAJOVEC, PO BOX 37428, RALEIGH, NC, 27627, US

(73) Assignee: Samsung Electronics Co., Ltd.

(21) Appl. No.: 11/300,530

(22) Filed: Dec. 14, 2005

(30) Foreign Application Priority Data
Dec. 17, 2004 (KR) 10-2004-0107995

(51) Int. Cl. H04N 11/02; H04N 11/04; H04B 1/66; H04N 7/12

(52) U.S. Cl. 375/240.16; 375/240.24; 375/240.29

(57) ABSTRACT

A deblocking filter includes a current macroblock buffer memory configured to store video data of a current macroblock to be filtered, a side macroblock buffer memory configured to store a portion of video data of neighboring macroblocks located on the side of the current macroblock, a register buffer array configured to store video data read from the current macroblock buffer memory for current filtering, video data read from the side macroblock buffer memory, and data of neighboring macroblocks, and an edge filter that is connected to the register buffer array and is configured to perform horizontal or vertical filtering on an edge of a subblock of the current macroblock of video data and to perform the other of horizontal or vertical filtering on an edge of a subsequent subblock of the current macroblock of the video data, simultaneously. Vertical filtering uses the data from the neighboring macroblocks and horizontal filtering uses the video data from the side macroblock buffer memory.

### CROSS-REFERENCE TO RELATED PATENT APPLICATION

This application claims the benefit of and priority to Korean Patent Application No. 10-2004-0107995, filed on Dec. 17, 2004, in the Korean Intellectual Property Office, the disclosure of which is incorporated herein by reference in its entirety.

### BACKGROUND OF THE INVENTION

1. Field of the Invention

The present invention relates to a video decoding, and, more particularly, to deblocking filters and methods of operating the same for removing a blocking artifact that may occur in H.264/advanced video coding (AVC) standard systems.

2. Description of the Related Art

Many video processing systems use standardized video codecs, such as H.261, H.262, and H.263 recommended by International Telecommunication Union (ITU). Codec standards, such as moving picture expert group (MPEG)-1, MPEG-2 and MPEG-4, are applied to those video codecs. Recently, research and standardization work has been conducted on H.264/AVC video codecs capable of achieving higher compression ratios.

In the H.264/AVC video coding standard, an image is compression-coded in block units and then decoded. As a result, a blocking artifact may occur in a decoded image. There are two major causes of a blocking artifact: First, because most compression techniques, along with H.264/AVC, perform discrete cosine transform (DCT) on blocks of a predetermined size and then quantization on the DCT transformed blocks, block units that do not overlap are separately transformed and quantized without consideration of correlations between their neighboring blocks or pixels, which may result in data loss and/or a blocking artifact. Second, because a motion vector is predicted on a block-by-block basis to compensate for an image, pixels included in a block have the same motion vector, which may result in a blocking artifact.

A deblocking filter may smooth out a block edge error that occurs in block-based coding and may improve the appearance of final decoded images. The H.264/AVC standard may be used with a deblocking filter function to prevent and/or reduce a blocking artifact. Unfortunately, such an implementation may make the implementation of a decoder complicated.

### SUMMARY OF THE INVENTION

According to some embodiments of the present invention, a deblocking filter includes a current macroblock buffer memory configured to store video data of a current macroblock to be filtered, a side macroblock buffer memory configured to store a portion of video data of neighboring macroblocks located on the side of the current macroblock, a register buffer array configured to store video data read from the current macroblock buffer memory for current filtering, video data read from the side macroblock buffer memory, and data of neighboring macroblocks, and an edge filter that is connected to the register buffer array and is configured to perform horizontal or vertical filtering on an edge of a subblock of the current macroblock of video data and to perform the other of horizontal or vertical filtering on an edge of a subsequent subblock of the current macroblock of the video data, simultaneously. Vertical filtering uses the data from the neighboring macroblocks and horizontal filtering uses the video data from the side macroblock buffer memory.

In other embodiments, the deblocking filter further includes an external memory that is configured to store filtered and unfiltered video data including the video data of the neighboring macroblocks.

In still other embodiments, the deblocking filter further includes a filtering output buffer memory that is configured to temporarily store video data filtered by the edge filter.

In still other embodiments, each of the current macroblock buffer memory, the side macroblock memory, and the output buffer memory comprises at least two buffer memories configured for a pipelined filtering operation.

In still other embodiments, the deblocking filter further comprises an external memory controller that is configured to read video data from the external memory and to store the read video data in the current macroblock buffer memory and/or the side macroblock buffer memory, and a register buffer array controller that is configured to read video data from the current macroblock buffer memory, the side macroblock buffer memory, and the external memory and to store the read video data in the register buffer array.

In still other embodiments, the register buffer array is configured to read subblock video data from the current macroblock buffer memory, video data from the side macroblock buffer memory, and video data or neighboring macroblocks from the external memory, store the read video data, temporarily store subblock video data filtered by the edge filter, and provide stored subblock video data of the current macroblock for filtering of a subsequent edge.

In still other embodiments, the deblocking filter further includes a filtering strength generator that is connected to the edge filter and is configured to determine a filtering strength for edge filtering, and a threshold generator that is connected to the filtering strength generator and the edge filter and is configured to determine whether to perform edge filtering. The filtering strength generator is separate from the edge filter.

In still other embodiments, the filtering strength generator is configured to generate a filtering strength using a motion vector generated during a motion vector generation process simultaneously with the motion vector generation process.

In still other embodiments, the edge filter comprises a plurality of filtering engines that operate separately for a chrominance or luminance component to allow vertical and horizontal edges of the subblock of the current macroblock to be simultaneously filtered.

In still other embodiments, the deblocking filter further includes buffer memory controllers, which are configured to control video data input/output to/from the current macroblock buffer memory, the side macroblock buffer memory, and the filtering output buffer memory, respectively.

In still other embodiments, the edge filter is configured to simultaneously perform filtering operations on a luminance component of the video data and a chrominance component of the video data.

In still other embodiments, the video data is configured for processing by an H.264/AVC video codec.

In further embodiments of the present invention, deblocking filtering of video data may be performed by dividing horizontal edges and vertical edges corresponding to a 16×16 macroblock of video data into edges of a 4×4 subblock, and performing deblocking filtering from a 4×16 block of a top horizontal edge of the 16×16 macroblock to a 4×16 block of a bottom horizontal edge of the 16×16 macroblock, such that for each 4×16 block horizontal filtering of vertical edges of four 4×4 subblocks and then vertical filtering of horizontal edges of the four 4×4 subblocks are performed.

In still further embodiments, performing deblocking filtering further includes performing horizontal filtering of a first 4×16 block, simultaneously performing horizontal filtering of a second 4×16 block and vertical filtering of the first 4×16 block, simultaneously performing horizontal filtering of a third 4×16 block and vertical filtering of the second 4×16 block, simultaneously performing horizontal filtering of a fourth 4×16 block and vertical filtering of the third 4×16 block, and performing vertical filtering of the fourth 4×16 block.

In still further embodiments, horizontal and/or vertical filtering of the respective 4×16 blocks includes receiving data of a first 4×4 subblock, simultaneously performing filtering of the first 4×4 subblock and receiving data of a second 4×4 subblock, simultaneously performing filtering of the second 4×4 subblock and receiving data of a third 4×4 subblock, simultaneously performing filtering of the third 4×4 subblock and receiving data of a fourth 4×4 subblock, and performing filtering of the fourth 4×4 subblock.

In still further embodiments, filtering of respective ones of the 4×4 subblocks comprises filtering four pixel lines simultaneously.

In still further embodiments, performing deblocking filtering comprises performing filtering operations on a luminance component and a chrominance component of the video data.

In still further embodiments, the video data is configured for processing by an H.264/AVC video codec

### BRIEF DESCRIPTION OF THE DRAWINGS

The above and other features and advantages of the present invention will become more apparent by describing in detail an exemplary embodiment thereof with reference to the attached drawings in which:

FIG. 1 is a block diagram of a conventional video decoder system;

FIG. 2 illustrates macroblocks used in a deblocking filtering operation;

FIGS. 3A and 3B are diagrams that illustrate an edge filtering order in a macroblock;

FIG. 4 is a block diagram of a deblocking filter according to some embodiments the present invention;

FIG. 5 is a diagram that illustrates an edge filtering order in a macroblock according to some embodiments of the present invention;

FIG. 6 is a block diagram that illustrates a pipeline structure in a filtering operation according to some embodiments of the present invention; and

FIG. 7 is a flowchart that illustrates deblocking filtering operations according to some embodiments of the present invention.

### DETAILED DESCRIPTION OF EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

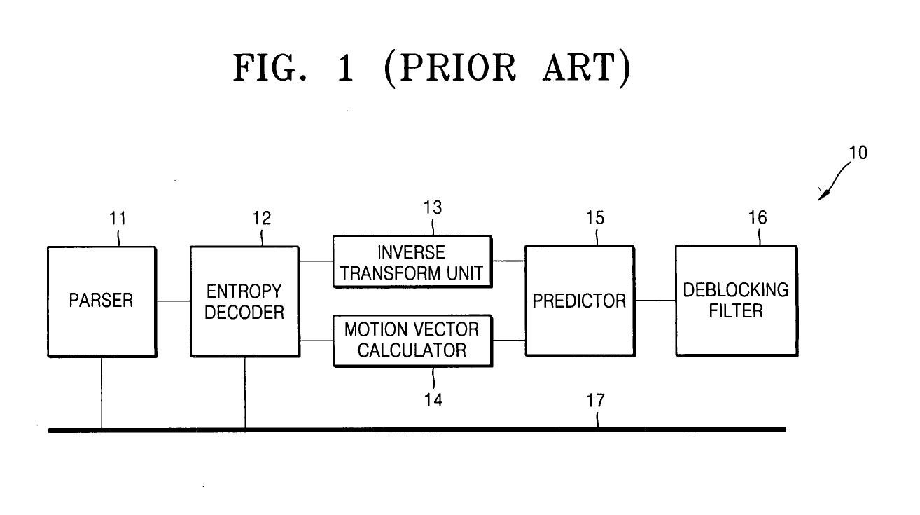

FIG. 1 is a block diagram of a conventional video decoder system. In general, compressed video data is decompressed into original data through a decoding process and displayed on a screen in a video processor. Referring to FIG. 1, a video decoder 10 for decoding video data includes a parser 11, an entropy decoder 12, an inverse transform unit 13, a motion vector calculator 14, an inverse inter/intra-prediction unit 15, a deblocking filter 16, a plurality of hardware modules (not shown), an external memory controller (not shown), and a personal computer interface (PCI) module (not shown).

Data used in the decoding process are read from or stored in an internal memory or an external memory, and the modules exchange data through a system bus 17 shown in FIG. 1. The decoding process is sequentially performed by the above-described hardware modules to decompress compressed video data into original data. Because video data is compressed and decompressed in marcoblock units, a block-based screen difference may occur at boundaries between blocks of a decompressed image. Such a blocking artifact may be reduced by the deblocking filter 16 of FIG. 1. Because the blocking artifact may be caused by compression of video data in blocks units of a predetermined size, edge filtering of the deblocking filter 16 may also be performed in macroblock units.

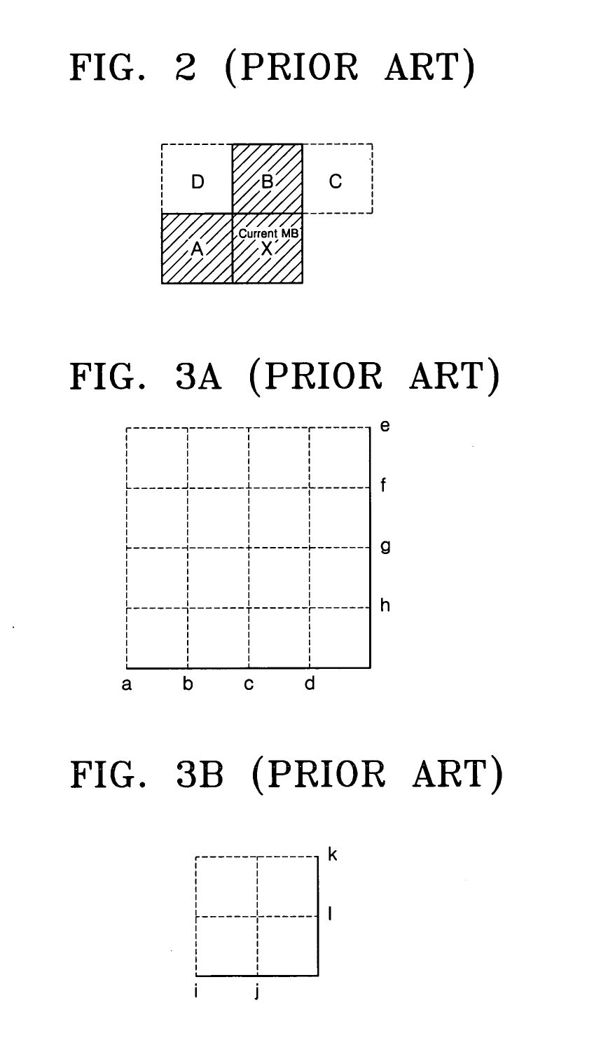

FIG. 2 illustrates macroblocks used in a deblocking filtering operation. Referring to FIG. 2, a current macroblock is marked with X, neighboring macroblocks of the current macroblock are marked with A, B, C, and D. As shown in FIG. 2, a macroblock located on the left side of the current macroblock X is marked with A, and a macroblock located above the current macroblock X is marked with B. To filter edges of the current macroblock X, data of the macroblocks A and B are required as shown in FIG. 2. In other words, the macroblock A located on the left side of the current macroblock A is required for horizontal filtering and the maroblock B located above the current macroblock B is required for vertical filtering.

FIGS. 3A and 3B are diagrams that illustrate an edge filtering order in a macroblock. Referring to FIGS. 3A and 3B, a filtering operation for a macroblock is performed on a luminance component and a chrominance component of pixels included in the macroblock. FIG. 3A shows boundaries of a luminance component to be filtered and FIG. 3B shows boundaries of a chrominance component to be filtered. Vertical boundaries of the luminance component are filtered in order a, b, c, d and horizontal boundaries of the luminance component are filtered in order e, f, g, h. Vertical boundaries of the chrominance component are filtered in order i, j and horizontal boundaries of the chrominance component are filtered in order k, l. In general, a luminance component is filtered before a chrominance component is filtered.

To perform a filtering operation, four pixels on either side of a horizontal or vertical boundary may be used. In other words, for a horizontal filtering operation, four pixels located on the left side of the vertical boundary and four pixels located on the right side of the vertical boundary may be used, and for a vertical filtering operation, four pixels located above the horizontal boundary and four pixels located below the horizontal boundary may be used. The number of pixels to be modified and an applied filtering strength may vary with quantization parameters used in a macroblock including neighboring 4×4 blocks, the coding mode of the neighboring 4×4 blocks, and/or motion vectors of neighboring 4×4 blocks.

As described above, when using a conventional filtering method, at least 800 cycles, including the time required for memory access and filtering, may be required for the filtering operation. As a result, a time delay may occur in a filtering operation for high-definition video data, which may cause difficulties in processing the high-definition video data in real time.

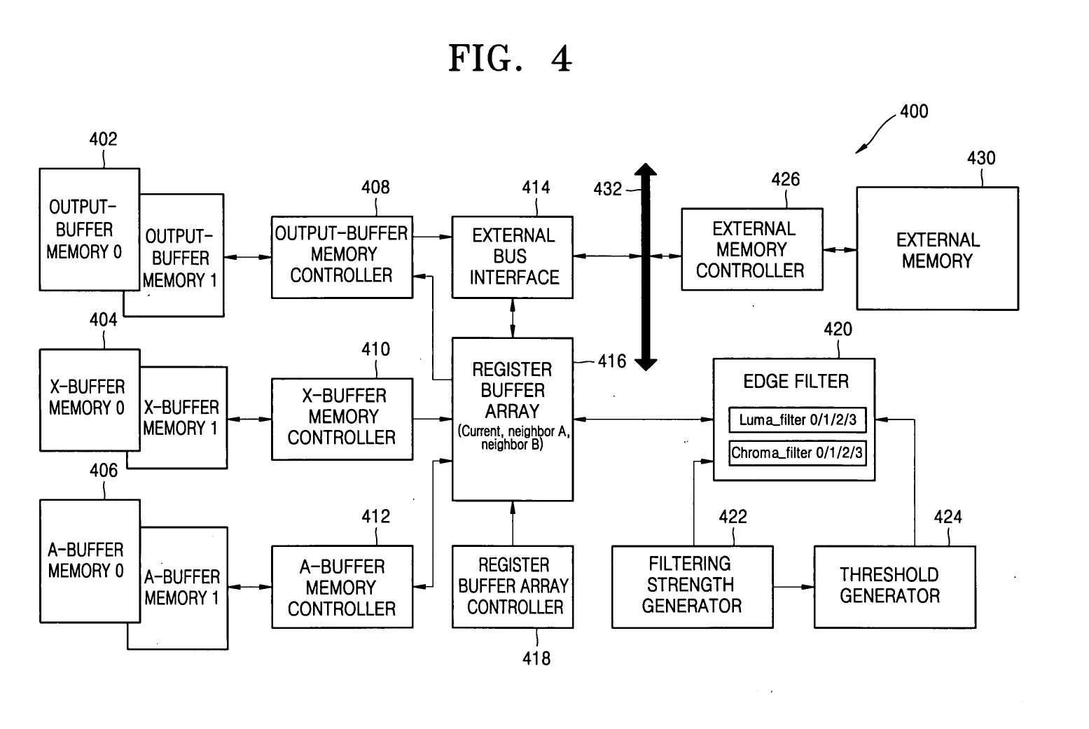

FIG. 4 is a block diagram of a deblocking filter according to some embodiments of the present invention. According to a deblocking filter algorithm, a pixel corresponding to an edge to be filtered is selected and the selected pixel is read from an internal or external memory and stored in a buffer for a filtering operation. To remain an edge portion of an actual image and prevent excessive filtering, a boundary filtering strength is obtained and compared with a threshold to determine whether to perform filtering. Such a deblocking filter algorithm is disclosed, for example, in the H.264/AVC standard.

The hardware structure of the deblocking filter 400, according to some embodiments of the present invention, is designed to reduce the number of memory accesses and allow for an efficient filtering operation. The deblocking filter 400 according to some embodiments of the present invention may also allow horizontal filtering and vertical filtering to be performed in parallel.

To this end, the deblocking filter 400, according to some embodiments of the present invention, includes two output buffer memories (0 and 1) 402, two X-buffer memories (0 and 1) 404, two A-buffer memories (0 and 1) 406, an output buffer memory controller 408, an X-buffer memory controller 410, an A-buffer memory controller 412, an external bus interface 414, a register buffer array 416, a register buffer array controller 418, an edge filter 420, a filtering strength generator 422, a threshold generator 424, an external memory controller 426, and an external memory 430, which are configured as shown.

The two output buffer memories (0 and 1) 402 are memories for temporarily storing data filtered by the edge filter 420 before outputting the data to the external memory 430. The two X-buffer memories (0 and 1) 404 are memories for storing data of a macroblock corresponding to an edge that is being filtered. In other words, the X-buffer memories (0 and 1) 404 store data of the current macroblock X of FIG. 2. The two A-buffer memories (0 and 1) 406 store data of four 4×4 subblocks that are adjacent to the current macroblock X among data of neighboring macroblocks located on the left side of the current macroblock X. The output buffer memory controller 408 controls data input and output of the output buffer memories (0 and 1) 402, the X-buffer memory controller 410 controls data input and output of the X-buffer memories (0 and 1) 404, and the A-buffer memory controller 412 controls data input and output of the A-buffer memories (0 and 1) 406. The external bus interface 414 performs an interface function, such as reading data used in a decoding process from an internal memory or an external memory, or storing the data in the internal memory or the external memory.

To perform a filtering operation, the register buffer array 416 stores data of a current macroblock, which is read from the X-buffer memories (0 and 1) 404, data of macroblocks located on the left side of the current macroblock, which is read from the A-buffer memories (0 and 1) 406, and data of macroblocks located above the current macroblock, which is read from the external memory 430, and stores data that is to be used in a subsequent filtering operation among data filtered by the edge filter 420. The edge filter 420 filters an edge using data stored in the register buffer array 416. The filtering strength generator 422 determines a filtering strength to restore an edge portion of an actual image and prevent/reduce excessive filtering, and the threshold generator 424 calculates a threshold to determine whether to perform filtering. The external memory 430 stores video data for filtering and stores filtered data. The register buffer array 418 controls the register buffer array 416, and the external memory controller 426 controls the external memory 430.

Operations of the deblocking filter 400, according to some embodiments of the present invention, will be described with reference to FIG. 4. To filter a macroblock, information associated with a current macroblock and information associated with neighboring macroblocks is used. In other words, information associated with a macroblock A located on the left side of the current macroblock is used to filter a vertical edge of the current macroblock, and information associated with a macroblock B located above the current macroblock is used to filter a horizontal edge of the current macroblock. As described above in the video decoder system of FIG. 1, the deblocking filter 16 receives information associated with a current macroblock to be filtered from the predictor 15 that is a stage before the deblocking filter 16 and stores the information in the X-buffer memories (0 and 1) 404. In some embodiments, the number of X-buffer memories is two for the efficient pipeline structure of the video decoder system.

A memory buffer for storing the neighboring macroblocks A and B to filter horizontal/vertical edges of the current macroblock is also used, and the A-buffer memory 406 stores information associated with the macroblock A located on the left side of the current macroblock and stores 4*32 pixel information based on an MBAFF mode. The number of A-buffer memories 406 is also two for the pipeline structure of the video decoder system, in accordance with some embodiments of the present invention.

In the case of an H.264/AVC main profile, when the information associated with the macroblock B located above the current macroblock supports a maximum resolution of 2048*1024, 128*4*32 pixel information is used based on an MBAFF mode. Here, 128 is the number of macroblocks included in a line of image. However, the amount of pixel information may be too much to be stored in an internal memory buffer. Thus, a structure in which the information associated with the macroblock B located above the current macroblock X is stored in the external memory 430 and necessary pixel information associated with the macroblock B is previously read prior to filtering and stored in the internal register buffer array 416 may be more efficient. Also, as shown in FIG. 4, to access the external memory 430, the external bus interface module 414 may be used to exchange data with the system bus 432.

In FIG. 4, the register buffer array 416 stores data used for a subsequent filtering operation among pixels used for a filtering operation and filtered pixels for a pipeline structure used for a high-speed filtering operation, thereby making it possible to process filtering efficiently. In other words, unlike the structure of general deblocking filters, the register buffer array 416, according to some embodiments of the present invention reads information used for edge filtering, performs a filtering operation, and stores the read information in a register until filtering of vertical/horizontal edges is completed, thereby facilitating a high-speed pipeline structure and reducing unnecessary memory access cycles.

The edge filter 420 receives pixel information from the register buffer array 416, a boundary filtering strength from the filtering strength generator 422, and a threshold from the threshold generator 424, and performs an actual filtering operation. For a high-speed filtering operation, the edge filter 420 includes four filtering engines that operate separately for a chrominance or luminance component to allow vertical or horizontal edges of 4×4 subblocks to be simultaneously filtered. Each of the four filtering engines filters pixels included in a line of data of each of the 4×4 subblocks.

The edge filter 420 of the deblocking filter 400, according to some embodiments of the present invention, simultaneously filters a luminance component and a chrominance component to reduce a time required for a filtering operation.

The deblocking filter 400, according to some embodiments of the present invention, is configured such that the filtering strength generator 422 is installed outside the edge filter 420, as shown in FIG. 4. To determine a filtering strength, motion vector information and a process of comparing various conditions may be used. Motion vector information is used in a stage before the predictor 15 in the general video decoder 10 shown in FIG. 1. Thus, it is conventional practice to store motion vector information in an internal memory and use the stored information when a filtering strength is generated. However, in the deblocking filter 400 according to some embodiments of the present invention, a filtering strength is generated during generation of a motion vector to share motion vector information without separately storing the motion vector information. By doing this, not only can internal memory be saved, but cycles required for a deblocking filtering operation can be reduced because a filtering strength is generated in a stage before a deblocking filter.

The two output buffer memories (0 and 1) for a pipeline structure temporally store filtered data and output the filtered data to the external memory 430.

The deblocking filter 400 performs a filtering operation in units of a 4×4 subblock and accesses at least two pixels for each block edge. As a result, the number of memory accesses increases, which may affect the performance of a decoder. Thus, the deblocking filter 400, according to some embodiments of the present invention, is configured such that the number of memory accesses can be reduced and horizontal filtering and vertical filtering can be efficiently performed in parallel.

According to a conventional filtering order, a horizontal edge is filtered after a vertical edge is filtered. In this case, to filter a macroblock, 64 horizontal filtering operations and 64 vertical filtering operations may be performed. If the number of cycles required for a memory access for data input/output and the number of cycles required for a filtering operation are about 15 cycles, a total of 1920 cycles is required, which may cause processing high-definition video data in real time to be difficult. However, the deblocking filter 400, according to some embodiments of the present invention, can reduce the number of memory accesses and cycles required for a filtering operation through a hardware structure that can simultaneously process filtering of vertical and horizontal edges.

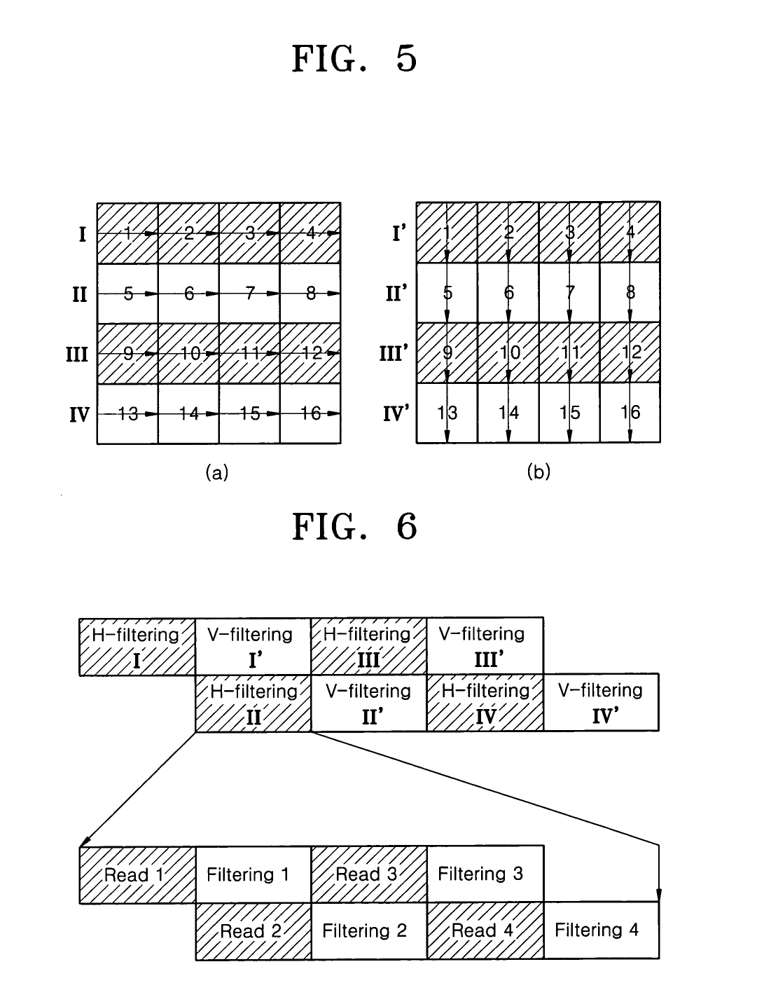

FIG. 5 is a diagram that illustrates an edge filtering order in a macroblock according to some embodiments of the present invention. In FIG. 5, a 16×16 macroblock is shown and each of 16 subblocks is a 4×4 block. Deblocking filtering of a macroblock starts from four 4×4 subblocks of the top horizontal line to four 4×4 subblocks of the bottom horizontal line. After horizontal filtering is sequentially performed on vertical edges of the four 4×4 subblocks, vertical filtering is sequentially performed on horizontal edges of the four 4×4 subblocks.

In other words, an order of filtering a macroblock is such that vertical filtering (I′) is performed on subblocks in order 1, 2, 3, 4 as shown in FIG. 5B after horizontal filtering (I) is performed on the subblocks in order 1, 2, 3, 4 as shown in FIG. 5A. After completion of vertical filtering (I′), horizontal filtering (II) is performed on subblocks in order 5, 6, 7, 8, and then vertical filtering (II′) is performed on the subblocks in order 5, 6, 7, 8. After completion of vertical filtering (II′), horizontal filtering (III) is performed on subblocks in order 9, 10, 11, 12, and then vertical filtering (III′) is performed on the subblocks in order 9, 10, 11, 12. After completion of vertical filtering (III′), horizontal filtering (IV) is performed on subblocks in order 13, 14,15,16, and then vertical filtering (IV′) is performed on the subblocks in order 13, 14,15, 16.

FIG. 6 is a block diagram that illustrates a pipeline structure in a filtering operation according to some embodiments of the present invention. A deblocking filtering method, according to some embodiments of the present invention, uses a 4×16 block as its basic processing unit. In other words, as shown in FIG. 5, filtering is performed sequentially on the four 4×4 subblocks 1, 2, 3, and 4 (i.e., a 4×16 block), the four 4×4 subblocks 5, 6, 7, and 8, the four 4×4 subblocks 9, 10, 11, and 12, and the four 4×4 subblocks 13, 14, 15, and 16. The deblocking filtering method, according to some embodiments of the present invention, processes horizontal filtering and vertical filtering in the form of a two-stage pipeline structure using a 4×16 block, i.e., four 4×4 subblocks, as its basic processing unit. In a 4×16 block, both horizontal filtering and vertical filtering are processed in the form of a two-stage pipeline structure using 4×4 block units.

The pipeline structure, according to some embodiments of the present invention, will be described with reference to FIGS. 5 and 6. After horizontal filtering (I) is performed on the first 4×16 block, vertical filtering (I′) of the first 4×16 block and horizontal filtering (II) of the second 4×16 block are performed simultaneously. Vertical filtering (II′) of the second 4×16 block and horizontal filtering (III) of the third 4×16 block are then performed simultaneously. Vertical filtering (III′) of the third 4×16 block and horizontal filtering (IV) of the fourth 4×16 block are then performed simultaneously. Finally, vertical filtering (IV′) of the fourth 4×16 block is performed.

In other words, in the deblocking filtering method according to some embodiments of the present invention, because horizontal filtering and vertical filtering are performed in the form of a pipeline structure, horizontal filtering is performed on the subblocks 5, 6, 7, and 8 while vertical filtering is being performed on the subblocks 1, 2, 3, and 4. Also, while vertical filtering is being performed on the subblocks 5, 6, 7, and 8, horizontal filtering is performed on the subblocks 9, 10, 11, and 12. While vertical filtering is being performed on the subblocks 9, 10, 11, and 12, horizontal filtering is performed on the subblocks 13, 14, 15, and 16. Finally, vertical filtering is performed on the subblocks 13, 14, 15, and 16.

In a 4×16 block, after data is input for the first 4×4 subblock, filtering of the first 4×4 subblock and data input for the second 4×4 subblock are performed simultaneously. Filtering of the second 4×4 subblock and data input for the third 4×4 subblock are then performed simultaneously. Filtering of the third 4×4 subblock and data input for the fourth 4×4 subblock are then performed simultaneously. Finally, filtering of the fourth 4×4 subblock is performed.

For example, in horizontal filtering of the first 4×16 block of FIG. 5, i.e., the 4×4 subblocks 1, 2, 3, and 4, while horizontal filtering of the 4×4 subblock 1 is being performed, data for horizontal filtering of the 4×4 subblock 2 is input. In the same way, while horizontal filtering of the 4×4 subblock 2 is being performed, data for horizontal filtering of the 4×4 subblock 3 is input. While horizontal filtering of the 4×4 subblock 3 is being performed, data for horizontal filtering of the 4×4 subblock 4 is input. Finally, horizontal filtering of the 4×4 subblock 4 is performed.

Therefore, the deblocking filtering method, according to some embodiments of the present invention, can simultaneously process horizontal filtering and vertical filtering with respect to a 4×16 block. Also, horizontal filtering and vertical filtering can simultaneously process data input and a filtering operation with respect to each 4×4 block.

To reduce a time required for a filtering operation, the deblocking filtering method, according to some embodiments of the present invention, simultaneously processes filtering operations with respect to a luminance component and a chrominance component.

A function of processing a filtering operation with a high-speed pipeline structure is implemented by the register buffer array 416 in the deblocking filter 400 according to some embodiments of the present invention, which is shown in FIG. 4. In other words, in the deblocking filtering method according to some embodiments of the present invention, vertical and horizontal filtering is performed in units of a 4×16 block, and a filtered 4×4 block is used for subsequent vertical filtering using the register buffer array 416 to reduce unnecessary memory accesses in a 4×4 block based filtering operation. Thus, a process of storing data in an internal buffer memory for subsequent filtering can be skipped, which results in a reduction of cycles required for a memory access.

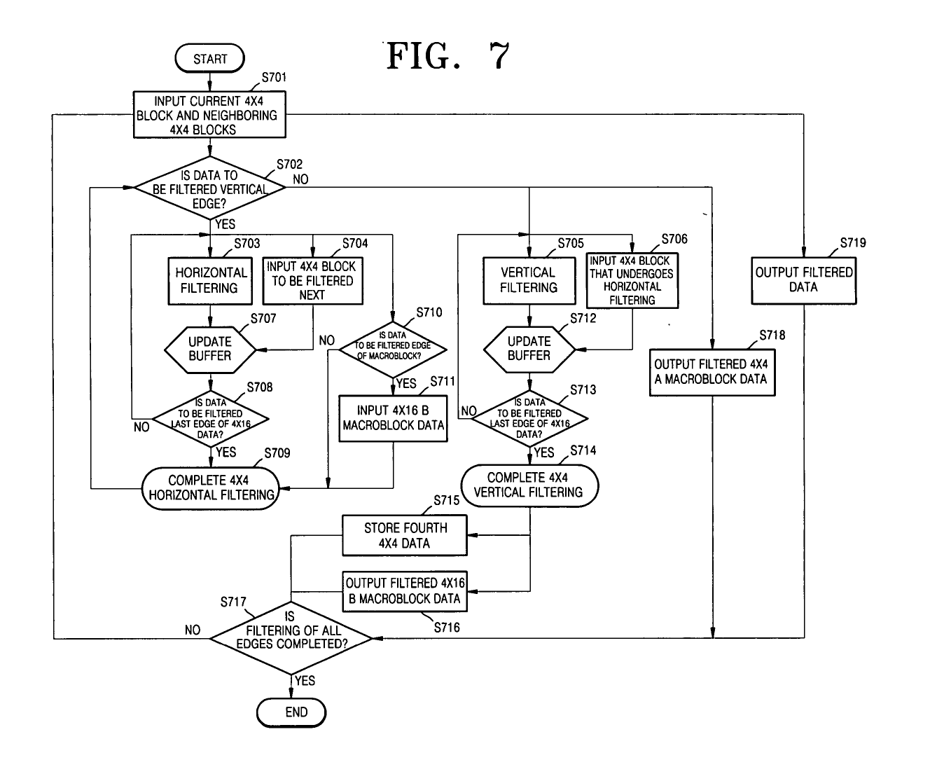

FIG. 7 is a flowchart that illustrates deblocking filtering operations according to some embodiments of the present invention. Referring to FIG. 7, data of a macroblock A for horizontal filtering of a vertical edge and the first 4×4 subblock of a macroblock X are read from internal X-buffer memories and stored in a register buffer array to provide data to be filtered (S701). After the data to be filtered is provided, it is determined whether the data to be filtered is a vertical edge in operation S702. If the data to be filtered is a vertical edge, horizontal filtering is performed in operation S703. While horizontal filtering is being performed on the data, data of the second 4×4 subblock of the macroblock X is provided to the register buffer array for subsequent horizontal filtering in operation S704. The register buffer array is updated with data that undergoes horizontal filtering and data of a 4×4 subblock to be filtered next in operation S707. Such a process is repeated until 4×4 horizontal filtering is completed in operations S708 and S709. While horizontal filtering is being performed, 4×16 data of a macroblock B for vertical filtering of the first or second subblock is provided from an external memory to the register buffer array in operations S710 and S711.

After completion of horizontal filtering of four vertical edges in the form of a pipeline structure, vertical filtering can be performed in operation S705. Data of the macroblock A that undergoes horizontal and vertical filtering can be output in operation S718.

Vertical filtering is performed in the form of a 4×4 block-based pipeline structure using 4×16 block data of the macroblock X that undergoes horizontal filtering and 4×16 block data of the macroblock B in operation S705 and, at the same time, the above-described horizontal filtering is performed on a subsequent vertical edge in operation S703. The register buffer array is then updated with data that undergoes vertical filtering and 4×4 subblock data that undergoes horizontal filtering in operation S712. Such a process is repeated until 4×4 vertical filtering is completed in operations S713 and S714.

After completion of vertical filtering, data of the fourth 4×16 block of the macroblock X is stored in A-buffer memories for deblocking filtering of a subsequent macroblock in operation S715 and, at the same time, data of the macroblock B that undergoes vertical and horizontal filtering is stored in output-buffer memories to be output to the external memory and is then output to the external memory during subsequent horizontal and vertical filtering in operation S716. The register buffer array is updated with data of the 4×4 macroblock X for subsequent vertical filtering. After such a process is performed on all vertical and horizontal edges, deblocking filtering of a macroblock is completed and filtered data is output to the external memory in operations S717 and S719.

According to the deblocking filter and deblocking filtering method, according to some embodiments of the present invention, a high-speed filtering operation can be performed using a pipeline structure that can simultaneously process data input, a filtering operation, vertical filtering, horizontal filtering, and data output.

In concluding the detailed description, it should be noted that many variations and modifications can be made to the preferred embodiments without substantially departing from the principles of the present invention. All such variations and modifications are intended to be included herein within the scope of the present invention, as set forth in the following claims.

That which is claimed:

1. A deblocking filter comprising:
a current macroblock buffer memory configured to store video data of a current macroblock to be filtered;
a side macroblock buffer memory configured to store a portion of video data of neighboring macroblocks located on the side of the current macroblock;
a register buffer array configured to store video data read from the current macroblock buffer memory for current filtering, video data read from the side macroblock buffer memory, and data of neighboring macroblocks; and
an edge filter that is connected to the register buffer array and is configured to perform horizontal or vertical filtering on an edge of a subblock of the current macroblock of video data and to perform the other of horizontal or vertical filtering on an edge of a subsequent subblock of the current macroblock of the video data, simultaneously, wherein vertical filtering uses the data from the neighboring macroblocks and horizontal filtering uses the video data from the side macroblock buffer memory.

2. The deblocking filter of claim 1, further comprising:
an external memory that is configured to store filtered and unfiltered video data including the video data of the neighboring macroblocks.

3. The deblocking filter of claim 2, further comprising a filtering output buffer memory that is configured to temporarily store video data filtered by the edge filter.

4. The deblocking filter of claim 3, wherein each of the current macroblock buffer memory, the side macroblock memory, and the output buffer memory comprises at least two buffer memories configured for a pipelined filtering operation.

5. The deblocking filter of claim 3, further comprising:
an external memory controller that is configured to read video data from the external memory and to store the read video data in the current macroblock buffer memory and/or the side macroblock buffer memory; and
a register buffer array controller that is configured to read video data from the current macroblock buffer memory, the side macroblock buffer memory, and the external memory and to store the read video data in the register buffer array.

6. The deblocking filter of claim 5, wherein the register buffer array is configured to read subblock video data from the current macroblock buffer memory, video data from the side macroblock buffer memory, and video data or neighboring macroblocks from the external memory, store the read video data, temporarily store subblock video data filtered by the edge filter, and provide stored subblock video data of the current macroblock for filtering of a subsequent edge.

7. The deblocking filter of claim 5, further comprising:
a filtering strength generator that is connected to the edge filter and is configured to determine a filtering strength for edge filtering; and
a threshold generator that is connected to the filtering strength generator and the edge filter and is configured to determine whether to perform edge filtering;
wherein the filtering strength generator is separate from the edge filter.

8. The deblocking filter of claim 7, wherein the filtering strength generator is configured to generate a filtering strength using a motion vector generated during a motion vector generation process simultaneously with the motion vector generation process.

9. The deblocking filter of claim 1, wherein the edge filter comprises a plurality of filtering engines that operate separately for a chrominance or luminance component to allow vertical and horizontal edges of the subblock of the current macroblock to be simultaneously filtered.

10. The deblocking filter of claim 5, further comprising buffer memory controllers, which are configured to control video data input/output to/from the current macroblock buffer memory, the side macroblock buffer memory, and the filtering output buffer memory, respectively.

11. The deblocking filter of claim 1, wherein the edge filter is configured to simultaneously perform filtering operations on a luminance component of the video data and a chrominance component of the video data.

12. The deblocking filter of claim 1, wherein the video data is configured for processing by an H.264/AVC video codec.

13. A deblocking filtering method, comprising:
storing video data of a current macroblock to be filtered;
storing a portion of video data of neighboring macroblocks located on the side of the current macroblock;
storing video data read from the current macroblock buffer memory for current filtering, video data read from the side macroblock buffer memory, and video data of neighboring macroblocks;
performing horizontal or vertical filtering on an edge of a subblock of the current macroblock of video data and the other of horizontal or vertical filtering on an edge of a subsequent subblock of the current macroblock of the video data, simultaneously, wherein vertical filtering uses the data from the neighboring macroblocks and horizontal filtering uses the data from the side macroblock buffer memory.

14. A deblocking filtering method, comprising:
dividing horizontal edges and vertical edges corresponding to a 16×16 macroblock of video data into edges of a 4×4 subblock; and
performing deblocking filtering from a 4×16 block of a top horizontal edge of the 16×16 macroblock to a 4×16 block of a bottom horizontal edge of the 16×16 macroblock, such that for each 4×16 block horizontal filtering of vertical edges of four 4×4 subblocks and then vertical filtering of horizontal edges of the four 4×4 subblocks are performed.

15. The deblocking filtering method of claim 14, wherein performing deblocking filtering further comprises:
performing horizontal filtering of a first 4×16 block;
simultaneously performing horizontal filtering of a second 4×16 block and vertical filtering of the first 4×16 block;
simultaneously performing horizontal filtering of a third 4×16 block and vertical filtering of the second 4×16 block;
simultaneously performing horizontal filtering of a fourth 4×16 block and vertical filtering of the third 4×16 block; and
performing vertical filtering of the fourth 4×16 block.

16. The deblocking filtering method of claim 15, wherein horizontal and/or vertical filtering of the respective 4×16 blocks comprises:
receiving data of a first 4×4 subblock;
simultaneously performing filtering of the first 4×4 subblock and receiving data of a second 4×4 subblock;
simultaneously performing filtering of the second 4×4 subblock and receiving data of a third 4×4 subblock;
simultaneously performing filtering of the third 4×4 subblock and receiving data of a fourth 4×4 subblock; and
performing filtering of the fourth 4×4 subblock.

17. The deblocking filtering method of claim 16, wherein filtering of respective ones of the 4×4 subblocks comprises filtering four pixel lines simultaneously.

18. The deblocking filtering method of claim 14, wherein performing deblocking filtering comprises performing filtering operations on a luminance component and a chrominance component of the video data.

19. The deblocking filtering method of claim 14, wherein the video data is configured for processing by an H.264/AVC video codec.
